(19) United States
(12) Patent Application Publication
(10) Pub. No.: US 2014/0287395 A1
(43) Pub. Date: Sep. 25, 2014

(54) METHOD AND SYSTEM FOR MEDICAL SKILLS TRAINING

(71) Applicants: Daniel Stephen Silverglate, Orlando, FL (US); Tu Thanh Lam, Oviedo, FL (US); Edward Mitford Sims, Orlando, FL (US)

(72) Inventors: Daniel Stephen Silverglate, Orlando, FL (US); Tu Thanh Lam, Oviedo, FL (US); Edward Mitford Sims, Orlando, FL (US)

(73) Assignee: VCOM3D, INC., Orlando, FL (US)

(21) Appl. No.: 14/219,912

(22) Filed: Mar. 19, 2014

Related U.S. Application Data
(60) Provisional application No. 61/804,926, filed on Mar. 25, 2013.

(51) Int. Cl. G09B 23/28

(52) U.S. Cl. CPC G09B 23/28
USPC 434/266; 434/262

(57) ABSTRACT

A method for medical skills training is provided that includes simulating a current condition of at least one simulated patient wherein the current condition comprises dynamic physiology, appearance, and behavior of the patient using one or more physiology models; outputting the simulated patient in the current condition on a visual display; receiving input from one or more users, wherein the input represents one or more medical interactions to be virtually applied to the simulated patient; processing the inputs using the physiology model in conjunction with one or more physiological variables that change over time based on the physiology model, in response to corresponding deterioration clocks and the inputs; and outputting one or more changes to the current condition of the simulated patient by applying different animations to the simulated patient based on the processed inputs. As system and computer readable media for medical skills training are also provided.

### CROSS REFERENCE TO RELATED APPLICATIONS

This application claims the benefit of U.S. Provisional Application Ser. No. 61/804,926 filed Mar. 25, 2013, incorporated herein by reference in its entirety.

### BACKGROUND OF THE INVENTION

This invention relates to a method and system for medical skills training and more particularly to a computer-implemented game-based method and system for medical skills training in a complex scenario using simulation and game technologies.

When faced with medical emergencies, especially those involving multiple casualties and multiple injuries, the decisions made by medical practitioners in a short amount of time can determine whether or not a patient lives and, if the patient lives, what quality of life the patient will have in the future. Research has shown that a practitioner's skill at saving lives, limbs, and bodily functions is dramatically improved by experience and deliberate practice. However, there are few opportunities to receive this kind of practice in real life. Physicians, nurses, and technicians may never have a chance to practice life-saving skills until faced with a real-life emergency.

In recent years, medical practitioners have practiced emergency response skills using computer-controlled medical mannequins. These mannequins simulate some of the physiological and behavioral properties of human patients. The more advanced mannequins include a basic physiology model that responds to medical interventions that are performed using simulated instruments. Use of these mannequin-based trainers requires that medical teams train together in the same location, and that each patient be represented by its own costly mannequin. More recently, simulation-based training has been developed that uses computer-generated “virtual humans” instead of costly mannequins as patients. These computer animations reduce facility, equipment, and logistics costs and make it possible to simultaneously simulate multiple patients in a single virtual environment. However, simply combining multiple simulated patients, whether physical mannequins or computer-generated virtual humans, in a single environment is not sufficient to simulate realistic and challenging emergency scenarios. A tractable and affordable method for simulating complex scenarios incorporating multiple physiological systems and, potentially, multiple patients, is needed.

A number of patents provide opportunities to practice the management of one or more patients with life-threatening injuries or illnesses, including U.S. Pat. No. 5,853,292, entitled “Computerized education system for teaching patient care,” issued 29 Dec. 1998, and U.S. Pat. No. 8,113,844, entitled “Medical Simulation Computer System,” issued 14 Feb. 2012. U.S. Pat. No. 5,853,292 describes human patient simulators that include a mechanical human model or “mannequin” integrated with computer-based physiology simulation, scenarios, and instrumentation. Such a mechanical simulation is expensive to manufacture, is prone to failure, and requires both maintenance and the replenishment of consumable materials such as simulated blood and urine. There are also many indications of patient condition, such as skin color and reflection, capillary refill, and facial movements that have not been satisfactorily or economically solved using mechanical simulations. U.S. Pat. No. 8,113,844 describes a Medical Simulation Computer System that links two or more simulations together. This method for linking two medical simulations requires the mediation of an instructor. It also requires that information be passed between the simulations of the various patient models. This causes the simulation of multiple patients to become exponentially more complex as the number of patients is increased. The system also does not provide a method for a first learner to interact with other learners, who may not be collocated with the first learner to collaborate to treat the multiple patients.

Hence, there is a need for a system and method for training decision-making skills for healthcare practitioners that allow simulations to be built and modified much more easily and economically. There is a further need in the art for a system and method that allows a learner to interact with any number of virtual patients and with any number of other real or virtual health practitioners. This allows realistic multiple patient scenarios to be simulated. A further need in the art is for a system and method that does not require information to be passed between the individual simulations of multiple patients, i.e., where no coupling of the various physiological variables is required. Such a simplification allows the number of patients to be increased without increasing the complexity of the system more than linearly with the number of patients. There is a further need in the art for a system and method that also allows the difficulty presented to the learner or learners to be varied easily. The present invention is designed to address these needs.

### BRIEF SUMMARY OF THE INVENTION

Broadly speaking, the invention comprises an improved system, method, and computer-readable media for medical skills training in a complex scenario using simulation and game technologies. The invention is optimally designed for training decision-making skills for healthcare practitioners.

Embodiments of the invention provide for a simulation of the physiology, appearance, and behaviors of one or more virtual patients and the effects of one or more healthcare practitioners' actions on each patient's physiology, appearance, and behaviors.

The physiology of each patient is modeled as any number of “deterioration clocks,” where each deterioration clock represents a physiological variable such as blood volume, organ perfusion, blood gases, or blood pressure. The appearance and behaviors of each virtual patient may be represented by such aspects as skin color, left and right pupil diameter, agitation, breath sounds, and vocalizations. The appearance and behaviors of the patients may vary as a function of the underlying physiological variables modeled by the deterioration clocks. For example, loss of blood may result in skin pallor in the virtual patient, while diminishing oxygenation of the blood may result in cyanosis.

The actions of at least one healthcare practitioner are controlled by a learner. The actions of each of the other practitioners may be controlled by other users of the system, or they may be controlled by computer-simulated virtual practitioners. The actions of each real or virtual practitioner may include assessments such as measurement of blood pressure or auscultation of body sounds; interventions such as tourniquet application or administration of fluids; or verbalizations such as questions or requests.

In use, the physiology, appearance, and behaviors of each patient, representing the patient's current condition, deteriorate over time unless successfully recognized, diagnosed, and treated by the real or virtual practitioners. The effect is to simulate the authentic perceptual cues that allow a learning practitioner to practice the diagnosis and treatment of virtual patients using realistic assessments and interventions. The learning practitioners can run the same simulated scenario any number of times while trying to improve performance, as represented by the vital signs, appearance, and behaviors of the virtual patients at the end of the scenario, and by the time required to achieve a desirable end state of said vital signs, appearance, and behaviors.

The invention can be implemented in numerous ways, including as a system, a device/apparatus, a method, or a computer readable medium. Several embodiments of the invention are discussed below.

As a method, an embodiment generally comprises simulating by a computing device the improvements in a virtual patient's condition that come from receiving inputs that apply correct interventions and simulating by a computing device the deteriorations in a patient's condition that come from receiving inputs that fail to provide correct interventions or from applying incorrect interventions. The physiology of each patient is modeled by a computing device using one or more deterioration clocks such that the physiology, appearance, and behaviors of each patient deteriorate over time unless successfully recognized, diagnosed, and treated by inputs received from real or virtual practitioners interacting with the simulation.

In further embodiments, as a method the invention comprises: (a) simulating by a computing device a dynamic physiology, appearance, and behavior of at least one simulated patient using one or more physiology models; (b) outputting the at least one simulated patient on an output device including a visual display; (c) receiving input from one or more users interacting with the computing device, wherein the input represents one or more medical interactions to be applied to the simulated patient, wherein the one or more medical interactions represent inputs that are adapted to recognize/assess, diagnose, and/or treat/apply interventions to the at least one simulated patient; (d) processing the received inputs by the computing device using the physiology model in conjunction with a deterioration clock that represents a physiological variable that deteriorates or improves over time based on the physiology model and the received inputs, wherein a difficulty level of the simulation is associated with a rate of the deterioration clock; and (e) outputting one or more changes to the physiology, appearance, and behavior of the at least one simulated patient by applying different animations to the physiology model based on the processed inputs.

The method of the present invention may be implemented in conjunction with a computing device and as part of a computer program product with a non-transitory computer-readable medium having code thereon. The computing device may include at least one processor, a memory coupled to the processor, and a program residing in the memory which implements the methods of the present invention.

As a system, an embodiment of the invention includes a computing device with at least one processor, a memory coupled to the processor, an output device having visual and audio output, an input device, and a program residing in the memory which implements the methods of the present invention.

As a non-transitory computer-readable medium, the invention comprises code devices for implementing the methods of the invention described herein.

The advantages of the invention are numerous, including no coupling of the physiological, appearance-related, and behavioral models of multiple patients being required. New patient models can be added to the system without the requirement to interchange information with the other patient models. This allows simulations to be built and modified much more easily and economically. Another advantage is that physiological systems of each patient model do not need to share information, although such sharing can be accommodated if desired. A further advantage is that the rate of deterioration of each patient and each physiological variable of each patient can be easily modified to increase or decrease the difficulty of the simulation by changing the parameters of the associated deterioration clocks. This modification may be effected prior to running a simulation, or during a simulation to change the difficulty for the learner or learners. The modification may also be performed by an instructor or may be performed automatically by a computer program to control the level of challenge for the learner or learners, in accordance with an estimate of the learners' capabilities.

Other aspects and advantages of the invention will become apparent from the following detailed description taken in conjunction with the accompanying drawings, illustrating, by way of example, the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows the major components of an embodiment of the medical game.

FIG. 2 is a screen displaying a stage of an embodiment of the medical game that provides practice in treating one or more patients in an emergency room.

FIG. 3 shows hardware components of an embodiment that may be involved in developing and implementing the medical game.

FIG. 4 shows software components of an embodiment that may be involved in developing and implementing game-based learning in a clinical environment.

FIG. 5 shows software components of an embodiment involved in simulating a physiological variable and its effects on patient vital signs, appearance, and behavior.

FIG. 6 shows user interface components and animations included in a preferred implementation of the invention.

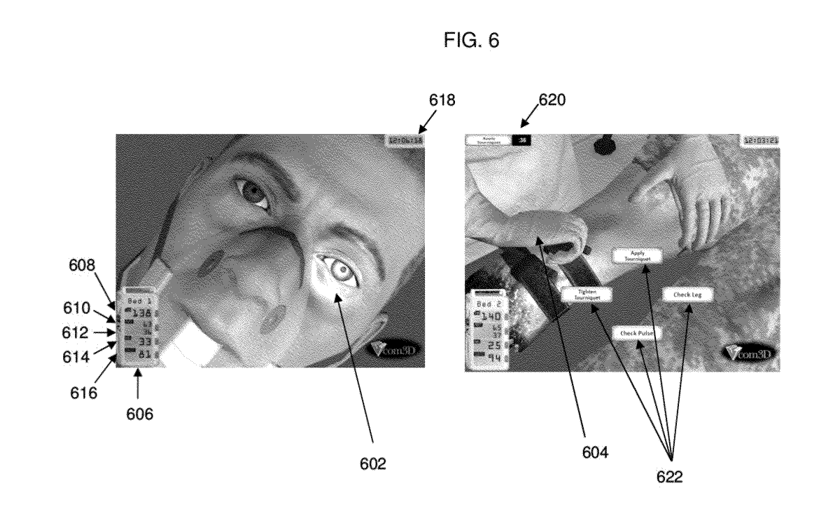

FIG. 7 shows of an embodiment of a multiple player version of the medical game.

### DETAILED DESCRIPTION OF THE INVENTION

Referring now to the drawings, the preferred embodiment of the present invention will be described.

Broadly speaking, the invention includes both hardware and software components. The hardware components include, for example: a general purpose computer; one or more graphic display devices; one or more user input devices. Optionally, the invention may also include: one or more audio output devices; one or more additional computer systems. The software components include, for example: a graphical user interface that allows the user to select one or more assessments or interventions to be performed from a list of available actions; one or more human character models that represent patients; a physiology model for each patient that represent the changes in one or more physiological variables as these variables are affected by the passage of time or by medical interventions; a virtual human model for each patient; animations of the patient character models representing appearances and behaviors that change according to changes in physiological variables; a game engine capable of rendering graphic representations of the human character models, medical equipment and substance models, and medical environment models. Optionally, the invention may also include: medical equipment and substance models; medical environment models; one or more virtual human models of medical practitioners; digitally stored sounds and verbalizations; medical procedure animations.

An embodiment of the invention is encompassed in an interactive medical game that includes a physiology model for each simulated patient. Each physiology model is a mathematical function that represents one or more physiological variables whose value is modified as a function of time to represent the deterioration that would take place if the corresponding patient were not treated. The medical game also includes a user interface whereby a learner may select an assessment/intervention to be performed on any of the simulated patients. When an intervention is selected, one or more physiological variables may transition to a new state in which that variable's value changes in accordance with a different function of time. For each patient, there is a virtual human model that is rendered by computer code executed on a computing device, such as a game engine. As each physiological variable for a patient changes over time, aspects of the patient's appearance and behavior may be changed by applying different animations to the model, using the rendering capability of the game engine. The effect is to simulate the improvements in a patient's condition that come from applying correct interventions and deteriorations in a patient's condition that come from failing to provide correct interventions or from applying incorrect interventions. By applying animations corresponding to realistic perceptual cues for the patients' conditions, the goal of simulating patient outcomes corresponding to medical procedures performed is achieved.

The realism and user experience of the invention can be enhanced in several ways including (1) rendering the patients in a simulated medical environment, such as a hospital emergency room, (2) including medical equipment and substances that are animated to show their operation, (3) including simulated practitioners, other than the learner, that are animated to respond to the user's selections, (4) including sounds of the patients, practitioners, or medical equipment, or (5) including animations of assessments and interventions performed by the user or other practitioners.

In use, an embodiment of the invention is operated by interacting with a simulated medical facility environment using standard computer user interface equipment such as a keyboard, mouse, and display. Alternatively, a touch screen display or speech recognition could be used. On the display are dynamic representations of one or more medical practitioners, one or more patients, and medical equipment in an environment. Typically, this environment will be a hospital room or other medical facility; however, the game could also be operated at a simulated point-of-injury or other point-of-care location where first responders treat a patient. The patient(s) exhibit dynamic appearances and behaviors related to their condition. The nature of their condition may also be represented by vital statistics display on a patient monitor device. Using a graphical user interface, text, or speech, the user may select interventions and assessments to be performed. As interventions are selected, they may result in improvement, stabilization, or deterioration of the patient(s) conditions.

In broad terms, a preferred embodiment of the system is comprised of a game engine, a number of digital media assets, a user interface, and game programming code that represents physiological models and the game play. The digital media assets include a 3D model of the medical environment (hospital room or other point-of-care location), 3D equipment models, and 3D human character models (for practitioners and patients). Procedure animations animate equipment models and character models to represent selected interventions and assessments. Human behavior animations animate human character models to represent patient behaviors and appearances. Finally sounds and verbalizations may be included to represent human voice and body sounds and/or equipment sounds. These models may be stored on a computer readable media accessible by the computing device.

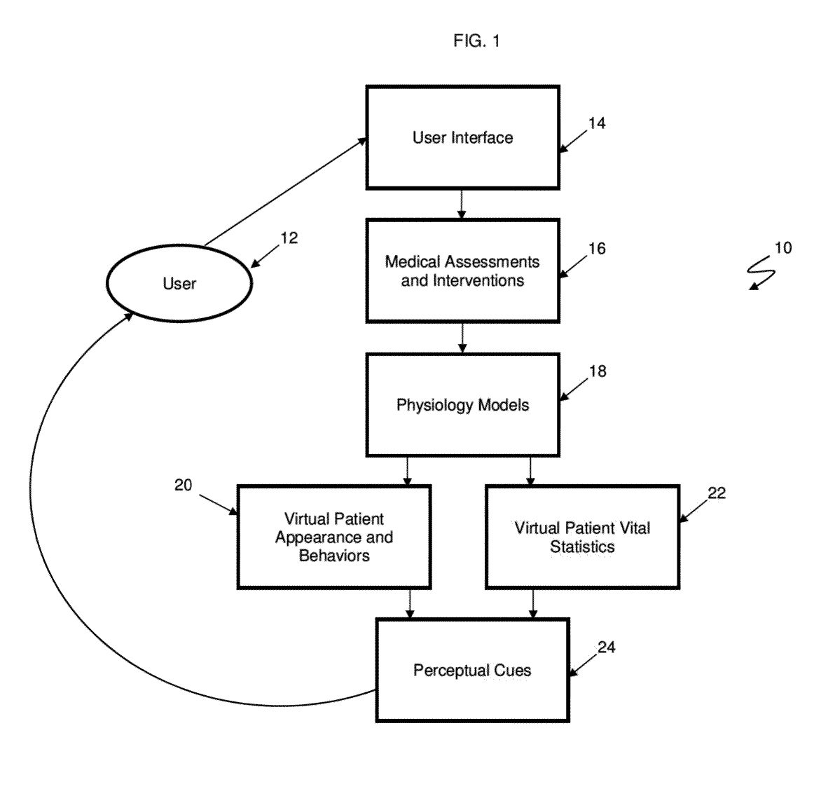

FIG. 1 shows major components of the medical game 10. A user 12 interacts with a user interface 14 to select medical assessments or interventions 16 to be performed on one or more virtual patients whose conditions are simulated by physiology models 18. These assessments and interventions may cause a change to the virtual patients' physiology as represented by physiology models 18. Changes in physiology may in turn cause changes in the virtual patient appearance and behaviors 20 or vital statistics 22. These changes in appearance, behaviors, and vital statistics provide perceptual cues 24 from which the diagnoses underlying conditions. Based on these diagnoses, the user may select additional medical assessments and interventions 16 using the user interface 14.

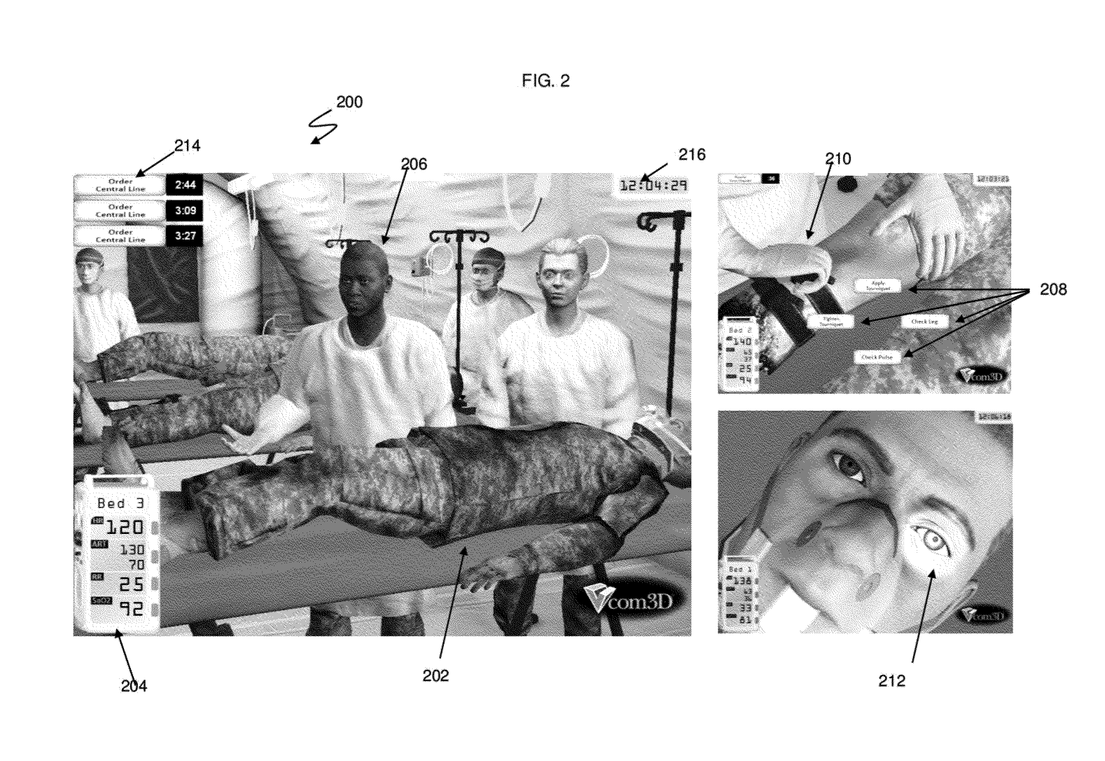

As shown in FIG.2, the medical game provides a visualization of one or more virtual patients 202 in a medical treatment environment. The medical treatment environment may be a temporary facility, as shown; a permanent facility such as a hospital; a medical evacuation vehicle; or other point-of-care. Each virtual patient's condition may be observed directly or through virtual instrumentation such as patient monitor 204. One or more virtual medical practitioners 206, each of which may be controlled directly by a player or by computer software, act to assess and treat the patients using interventions that are selected using a graphical user interface 208 and are displayed through animation of medical equipment, such as a tourniquet 210, of a practitioner 206, or of patient behavior 212. Procedure clocks 214 may show the amount of time remaining before a procedure is completed. A real-time current time clock 216 may show the current time.

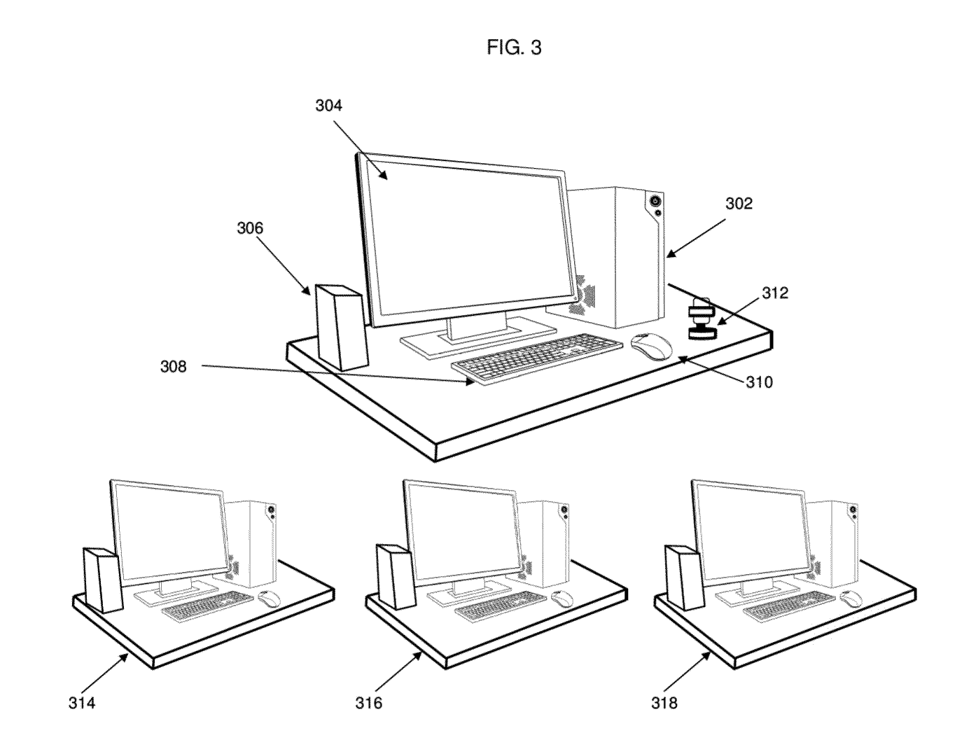

As shown in FIG. 3, the hardware components of the game include standard computer workstation components, including a computer 302, a display device 304, an audio output device 306, and user interface devices such as a keyboard 308 and mouse 310. Instead of a separate display device, keyboard, and mouse, it is also possible to use a touch screen that combines user input and display devices. It is also possible to use a device such as a tablet computer or smartphone that integrates all of these functions into one unit. Optionally, the workstation may include a voice input device 312 such as a microphone. The voice input and audio output devices may optionally be combined into a headset or into the computing device.

More than one workstation 314, 316, and 318 may be networked together to provide a multi-player version of the game. In this case, a user at workstation 314 can control a practitioner character that can be viewed and heard at workstations 316 and 318. Similarly, a user at workstation 316 or 318 can control a character that can be viewed at either of the other workstations. There is no specific limit to the number of users and workstations that may be networked together. In practice, this allows different users to play different practitioner roles, such as physician, nurse, and technician. The network between the workstations can be provided by Ethernet, Wi-Fi, or any of several digital means for networking computers that are well known in the field. Information required to integrate functions can be passed among the multiple workstations using Internet Protocol (IP), Voice over Internet Protocol (VoIP), User Datagram Protocol (UDP), Transmission Control Protocol (TCP), or any of several protocols also well known in the field.

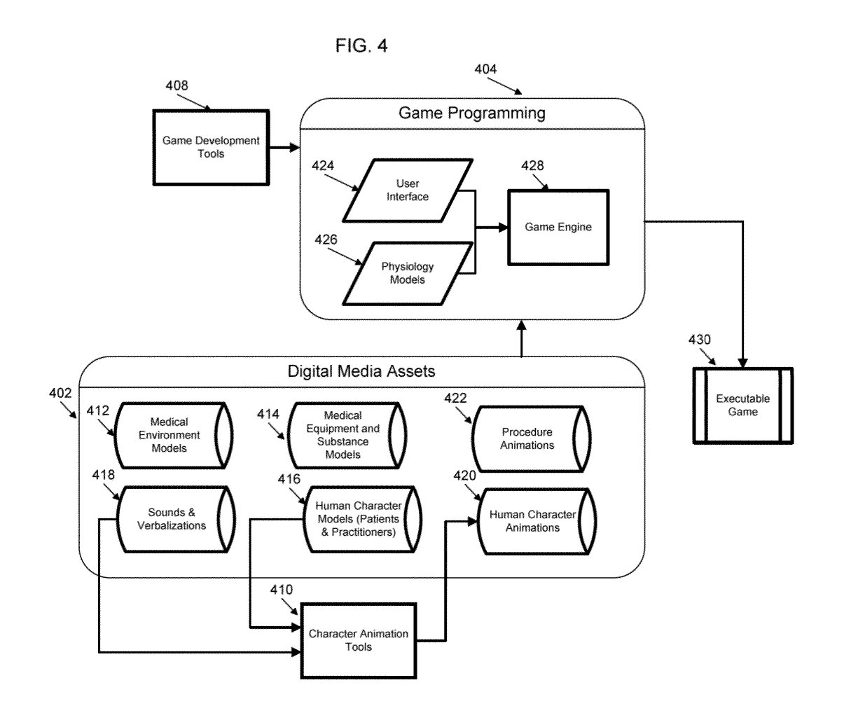

As shown in FIG. 4, the medical game is created using digital media assets 402, game programming 404, and, optionally, game development tools 408 and character animation tools 410 that simplify game development. Digital media assets 402 are images, 3D shapes, sounds, text, animations, and other media that are represented in standard digital formats such as jpg (for images), avi (for video), way (for sound), or fbx (for 3D shapes and animations). The subject invention does not require specific digital formats, as long as the formats are compatible with the game programming 404.

The game programming 404 is a set of instructions that describe operations to be performed by the game engine 428, including what digital media assets 402 to render and at what time and under what conditions to render them. The game programming 404 also may control certain parameters such as speed, simulated position and orientation, and other controllable features of each digital media asset. The game programming 404 may also interpret events such as passage of time, mouse clicks, key presses, and speech input and use these events to control the parameters of the various digital media assets 402. These events may either directly control the parameters, or may be evaluated by functions such as mathematical formulas or state machines that map one or more events to one or more animations. Among other applications, these functions may be used to simulate real-world phenomena such as physical, physiological, or psychological behavior.

The game engine 428 can be any of numerous software frameworks that provide the underlying functionality of an interactive three-dimensional (3D) game. A suitable embodiment uses the Unity Game Engine (Unity Technologies), but any game engine could be used. Although the game engine may include any number of optional components, the following software/hardware components are used in a preferred embodiment of the current invention having a capability and/or being adapted to: render models of 3D environments and objects in correct perspective and with correct color and brightness on a visual display relative to a specified eye point; set and modify the position, orientation, and field of view of an eye point for which the 3D objects are rendered in response to an external control; update the position and orientation of a 3D object and its parts on a digital display in response to changing position or orientation of the object or the eye point; update the color and brightness of a 3D object and its parts on a digital display in response to changing lighting; render complex models of 3D objects in correct perspective and with correct color and brightness on a computer screen, relative to a specified eye point, where the shape and/or configuration of the model changes over time in response to animations that specify the position and/or orientation of articulations of the complex objects and how these positions and orientations change with time; render models of 2D objects with a correct position, size, and color. These 2D objects may include buttons, alphanumeric characters, dials knobs and other shapes that provide information to the user or indicate controls that the user may manipulate. The position, orientation, and appearance of these 2D objects may be changed over time as a function of external controls; render either recorded or synthesized sounds in response to an external control; sense user inputs. These user inputs may be provided using standard mechanical devices such as a mouse or game pad; or they may be activated by sounds or speech, using any of a number of well-known computer-based methods for recognizing sounds and speech. Typically, user selections will be represented graphically on the visual display using a cursor, highlighting, or text. An Application Programmer's Interface (API) may also be provided that allows software developers to add procedures and interactivity using one or more computer programming languages. This ability to create new games may be further augmented by including libraries of reusable code and media assets, as well as game development tools.

Game engines such as described here provide the underlying framework for numerous games that are developed by individuals and/or organizations. Game developers skilled in the art will be familiar with the architecture, capabilities, and methods for developing games with such game engines. Among the books available that describe game engines and their role in game development is Game Engine Architecture. (Gregory, Jason. Game engine architecture. Wellesley, Mass.: A K Peters, 2009. Print).

In order to implement the medical game, digital media assets 402 may include medical facility models 412, medical equipment and substance models 414 (e.g., patient monitor, ventilator, body fluids), human character models 416 (for patients and practitioners), sounds & verbalizations 418 (e.g., physician's orders and questions, patient responses, patient breath sounds, equipment sounds), human character animations 420 (e.g., walking, using stethoscope), and procedure animations 422 (e.g., applying a tourniquet). The various digital media assets 402 may be created for a specific game, or they may be selected from a library of general purpose assets.

The game programming 404 may include a user interface 424 and physiology models 426, as well as the game engine 428. Any one of numerous user interface types, for which software components are readily available and well known in the field, may be used to register user input. Examples of such user interface types include drop-down lists, radio buttons, 3D object selection, text input, radial menus, and automatic speech recognition. Using the tools provided with the game engine, the game programming 404, including digital media assets 402, is delivered as an executable game 430.

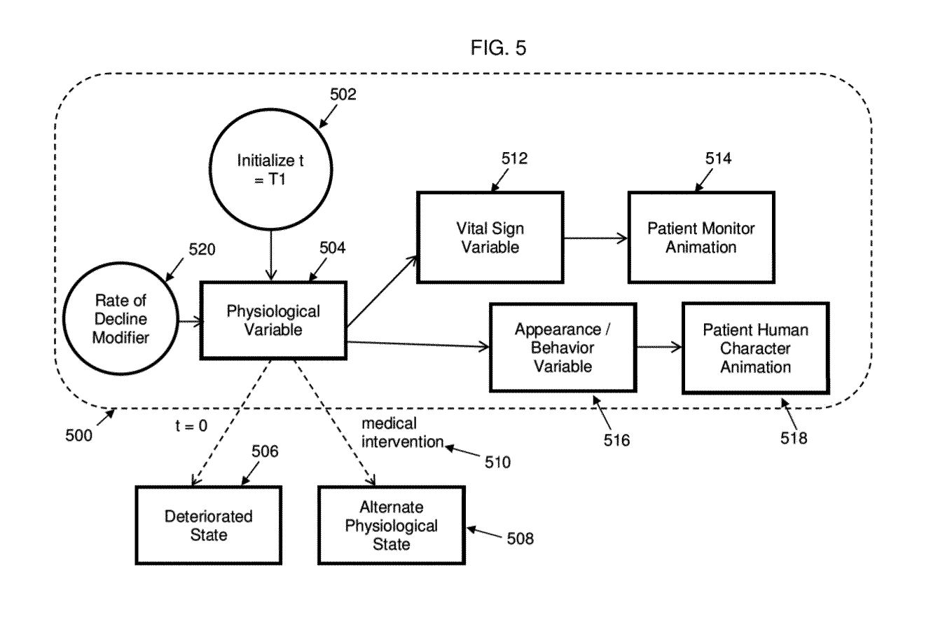

The primary innovation of the medical game is the method by which physiological models 426 are implemented and by which they modify the appearance and/or behaviors of the virtual patient human character models 416, medical equipment and substances 414, by activating human character animations 420, procedure animations 422, and sounds and verbalizations 418. Each physiological model 426 includes any number of physiological states 500, each of which represents a physiological variable 504 for that state and the conditions under which modeling of that physiological variable transitions to a fully deteriorated state 506 or an alternate state 508, as shown in FIG. 5.

The physiological model 426 for each patient is represented by multiple states 500. Each physiological variable 504 corresponds to one underlying medical condition (e.g. blood volume, airway patency). The initial state of each of each physiological variable 504 is set for some quantity of time T1 remaining 502. This quantity is continuously reduced in real time. If the time diminishes to 0, the variable transitions to a deteriorated state 506. The deteriorated state may be death, or it may be some other state such as loss of consciousness of irreversible organ damage. A user-initiated medical intervention 510 may be programmed to cause a transition to an alternate state 508. This alternate state may be a condition of stability that does not further deteriorate, a reduction in the rate of decline, or a worsening of condition, if a medical error has been made. In either case, the alternate state may be represented by a different finite state machine 502.

Associated with physiological variable 504 are a set of patient appearances/behavior variables 516, and vital statistics 512. The behaviors are assigned a priority ranking. Though multiple physiological variables are being computed concurrently for a patient, they are driven by the same mechanisms of time remaining and user interventions are thus synchronized. At any given time, each virtual patient is simultaneously in a single state for each physiological variable 504. The manifested behavior is resolved based on behavior priority, the perceptual cues are displayed concurrently, and the most critical value for each vital statistic is reported.

Referring to FIG. 5, a physiological variable can model any of a number of conditions affecting vital sign variables 512 or appearance/behavior variables 516 of a virtual patient. The specific physiological variables modeled for a medical game will depend on the diseases or injuries of the virtual patients. For example, for a patient losing blood due to wounds, it will be important to model the effects of this blood loss, which would lead, if untreated, to lowering blood pressure, increased heart rate, pallor of the skin, and diminished cognitive function, as the patient advances to hypovolemic shock and, eventually, death. By contrast, a primary variable to be modeled for an obstructed airway would be diminishing ventilation, leading to diminishing oxygenation, cyanosis, and diminished cognitive function. In further aspects herein, the rendering of the simulated patient may be varied to show changes in skin appearance such as pallor, cyanosis, rubor, sweat, contusion, or edema, in response to physiological changes. Moreover, the behavior of the simulated patient may be varied to show varying levels of alertness, pain, or agitation, in response to physiological changes, as evidenced by, for example, pupillary response, writhing, protection of painful areas, or vocalizations.

At the start of the medical game, all physiological variables are initialized 502 with a starting value and with a period of time T1 before they deteriorate to a point where the patient enters a deteriorated state 506. This period of time may be different for different physiological variables. The deteriorated state may be death, or it may be alternate dynamic physiological state 508 Associated with each Physiological Variable 504 may be one or more vital sign variables 512 and one or more appearance/behavior variable 516. As a physiological variable deteriorates or ameliorates, it will modify the value of the associated vital sign variables 512 and appearance/behavior variables 516. Each vital sign variable will control the patient monitor animation 514. Each appearance/behavior variable will control the associated patient human character animation 518. Examples of vital sign variables include heart rate, diastolic and systolic blood pressure, respiration rate, and oxygenation. Patient monitor animations include text displays of the vital sign variables, and may also include graphical displays such as EKG waveforms and sounds such as pitch changing with oxygenation level. Appearance/behavior variables may include patient agitation, bruising, hemorrhaging, amputation, breathing and edema. Patient human character animations include vocalizations, local or global skin color changes, blood flow, chest movements and sound, and swelling. These are only examples of the range of variables and animations that may be included.

As an option, a rate of decline modifier 520 of a physiological variable 504 may be modified to increase or decrease the rate of decline of a virtual human patient's condition. This rate of decline may be applied individually to one or more variables, or it may be modified for all physiological variables equally, so as to increase or decrease the difficulty of the game.

In use, as shown in FIG. 2, operation of the invention involves displaying for observation one or more virtual human patients 202, including their appearance and behaviors, and their vital signs on a patient monitor 204. Through these observations, the user infers underlying causes and selects appropriate medical interventions from a user interface 208, the selection being received by the computing device. These interventions may be performed by the user, or they may be assigned to other virtual medical practitioners 206. If appropriate interventions are selected, processing by the computer will result in the virtual human patients' physiological parameters being improved, and this will be shown by specifically implemented changes in their appearance, behavior, and/or vital signs. The computing device will output for the user to receive an indication of the level of their performance based on the condition of the virtual human patients at the end of the game and the amount of time required to get them to that condition.

The preferred way to make the invention is to use standard commercial computer hardware and software for the user interface, for standard graphical models, and for the graphics and audio rendering, and to add custom coding for the physiology models, animations, and gameplay functions in accordance with the unique aspects of the invention.

The preferred implementation of the game engine 428 and game development tools 408 is to use a commercial integrated game development environment such as Unity Pro Editor (Unity Technologies). The integrated game development environment includes game development Tools 408 for quickly browsing and finding digital media assets 402; placing these assets into a hierarchy; adjusting the positioning, timing, and attributes of these assets; adding scripted behaviors of the assets; and rendering a preview of the executable game 430 using embedded game engine 428. In this preferred implementation, the various digital media assets 402 may be either standard commercial off-the-shelf components available from multiple suppliers in standard digital formats such as Filmbox (FBX), or they may be specifically built for the invention using commercially available software such as Autodesk's Maya® or Autodesk's 3ds Max computer graphics software. In order to provide a high level of visual cues for assessing patient conditions, the preferred implementation uses Vcom3D's Vcommunicator® human character models 416 with highly articulated hands and faces. The preferred implementation also uses commercial character animation tools 410 such as Vcom3D's Vcommunicator® Studio to animate detailed facial expression changes such as pupil contraction 602 and detailed hand motions such as application of a tourniquet 604. In the preferred implementation, vital signs 606 including heart rate 608, Diastolic Blood Pressure 610, Systolic Blood Pressure 612, Respiratory Rate 614, and Blood Oxygenation 616 can be displayed for any patient at any time. A Real-time Clock 618 and any number of Procedure Clocks 620 show the actual wall clock time or elapsed time and time remaining to complete each of any number of procedures at any given time. Available procedures are displayed using a Radial Menu 622 based on the body area that the user selects.

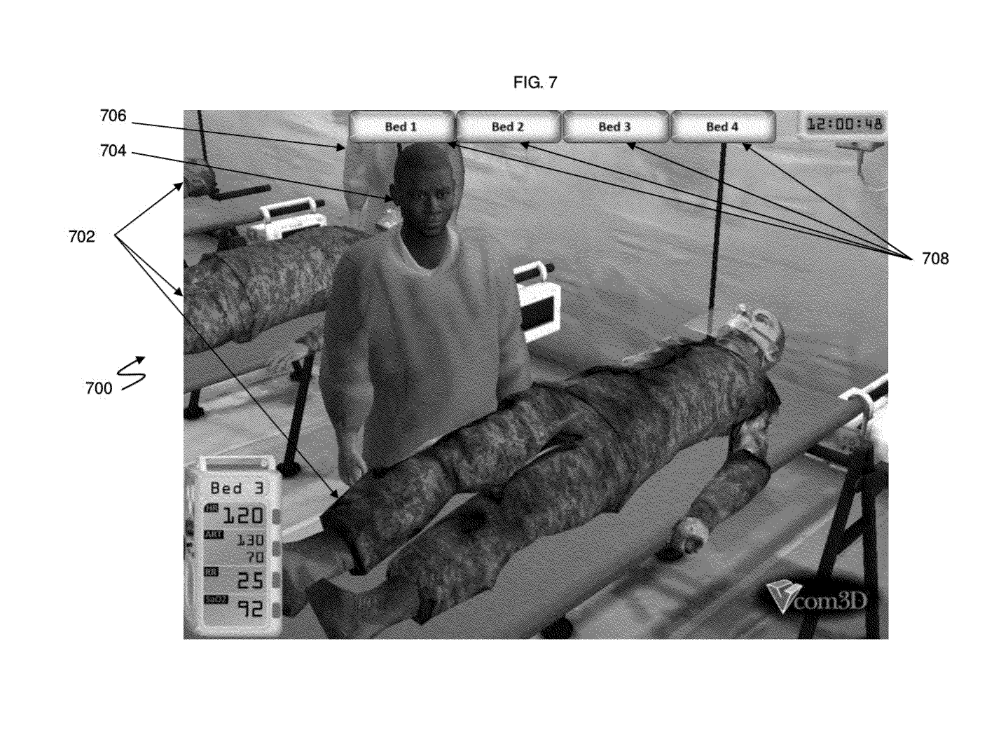

An alternate version of the invention involves networking multiple workstations 314, 316, and 318 together as shown in FIG. 3. In this alternate version, each user controls one of the practitioner human characters that can be observed on each of the other workstations. This alternate version allows team members, taking on different practitioner roles to practice working together. For example, as shown in FIG. 7, the user at workstation 312 may see a second virtual practitioner 704 controlled by the user at workstation 314 and a third virtual practitioner 706 controlled by a user at workstation 316. The methods to control the actions of a virtual character are well known in the field and are included in game engines such as the Unity game engine (Unity Technologies). In this alternate version, voice communication between the multiple users may be provided using Voice over Internet Protocol (VoIP). Any of the multiple users can move through the medical environment using selection buttons 708 or by using methods of navigation provided by the game engine.

The following is a specific example scenario which illustrates procedures for practicing the invention. This example should not be construed as limiting. In a first example of practicing the invention, the medical game can be used to simulate treatment of trauma patients in a field hospital emergency room 700. In this example, a physician may direct the actions of a nurse represented by second virtual patient 704 and technician represented by third virtual patient 706, each of which may be controlled by another user or by the game engine 428.

Advantages and features of the invention are numerous, and include the following: the rate of change of selected physiological variables may be adjusted to increase or decrease the difficulty of the simulation; the output of the simulation may be displayed in a simulated medical environment, such as a point-of-injury, ambulance, or emergency room; the output device may include a capability for sound output; the behavior of at least one simulated patient may include vocalizations of the patient; the behavior of at least one simulated patient may include simulated sounds of the simulated patient's circulatory, respiratory, or digestive systems; the behavior of at least one simulated patient may include simulated sounds of the medical equipment being used to treat the patient; one or more medical interactions may be simulated by animating simulated medical equipment and/or medical substances in a manner that shows their operation; one or more medical interactions may be simulated by animating a representation of the simulated user in a manner that shows the performance of medical procedures; one or more medical interactions may be simulated by animating one or more simulated medical personnel other than the user in a manner that demonstrates the performance of medical assessments or procedures; the performance of medical assessments or procedures performed by one or more simulated medical personnel other than the user may be controlled directly by the user; the performance of medical assessments or procedures performed by one or more simulated medical personnel other than the user may be controlled directly by players other than the user; each player may interact with the game through a separate display and input device; the user may control the game through a graphical user interface, speech recognition, a touch screen display, and/or an instrumented physical device (e.g., a simulated physical body part—with a device for injecting fluid into a simulated vein), which would inform the computing device that an intervention had been made.

An exemplary system for implementing the invention includes a computing device or a network of computing devices, including handheld computing devices such as smartphones, tablets, portable data devices, etc. The computing device may also be in communication with a central computing device via communication means, including a central server based system accessible via the Internet or intranet. In a basic configuration, computing device may include any type of stationary computing device or a mobile computing device. Computing device typically includes at least one processing unit and system memory. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable non-transitory media implemented in any method or technology for storage of information, such as computer readable instructions, data structures, program modules or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device.

Computing device may also have input device(s) such as a keyboard, mouse, pen, voice input, touch sensitive input, etc. Output device(s) such as a display, speakers, printer, etc. may also be included. Computing device may also contain communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Computer program code for carrying out operations of the invention described above may be written in a high-level programming language, such as a game development system, C, JAVA, or C++, or scripting language, for development convenience. In addition, computer program code for carrying out operations of embodiments of the present invention may also be written in other programming languages, such as, but not limited to, interpreted languages. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of the present invention creating a new machine. The general purpose computer becomes a special purpose computer once it is programmed to perform particular functions pursuant to instructions from program software of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It should be understood that the examples and embodiments described herein are for illustrative purposes only and that various modifications or changes in light thereof will be suggested to persons skilled in the art and are to be included within the spirit and purview of this application.

1. A method for medical skills training, comprising:
a) simulating by a computing device a current condition of at least one simulated patient wherein the current condition comprises dynamic physiology, appearance, and behavior of the simulated patient using one or more physiology models;
b) outputting the simulated patient in the current condition on an output device comprising a visual display;
c) receiving input from one or more users interacting with the computing device, wherein the input represents one or more medical interactions to be virtually applied to the simulated patient;
d) processing the received inputs by the computing device using the physiology model in conjunction with one or more physiological variables that change over time based on the physiology model, in response to corresponding deterioration clocks and the received inputs; and
e) outputting one or more changes to the current condition of the simulated patient by applying different animations to the simulated patient based on the processed inputs.

2. The method of claim 1, wherein the one or more medical interactions represent inputs that are adapted to recognize, assess, diagnose, treat, and/or apply interventions to the at least one simulated patient.

3. The method of claim 1, wherein the one or more physiological variables that change over time are associated with one or more alternate or deteriorated states, wherein a response of corresponding physiological variables to the deterioration clocks and received inputs will vary based on the alternate or deteriorated state.

4. The method of claim 1, wherein each of the one or more physiology models comprises a mathematical function that represents one or more physiological variables whose value is modified as a function of time to represent the current condition of the patient comprising an improvement, stabilization, or deterioration of the simulated patient based on the one or more medical interactions received or not received as input and the corresponding deterioration clocks.

5. The method of claim 1, further comprising rendering a virtual environment for the simulation comprising one or more of:
i) rendering the simulated patient in a simulated medical environment,
ii) rendering animated medical equipment and/or substances in operation,
iii) rendering a simulated user,
iv) rendering other simulated practitioners,
v) outputting sounds of the simulated medical environment including one or more vocalizations or sounds of the simulated patient, simulated user, other simulated practitioners, or animated medical equipment and substances, and
vi) rendering animations of the one or more medical interactions received as input.

6. The method of claim 5, wherein the sounds of the simulated patient comprises one or more of sounds of circulatory, respiratory, or digestive systems.

7. The method of claim 5 wherein rendering animations of the one or more medical interactions received as input, comprises one or more of:
animating the simulated medical equipment and/or substances in a manner that shows operation;
animating the simulated user in a manner that shows a performance of medical assessments or procedures; and
animating the other simulated practitioners in a manner that demonstrates a performance of medical assessments or procedures.

8. The method of claim 7, wherein the simulated user and the other simulated practitioners are adapted to be controlled at least in part by inputs received during the simulation from the one or more users interacting with the computing device.

9. The method of claim 1, wherein, when an intervention is received as input, the one or more physiological variables transition to a new state in which that variable's value changes in accordance with a different function of time.

10. The method of claim 1, wherein the simulation utilizes digital media assets comprising one or more of: medical facility models, medical equipment and substance models, human character models, sounds and verbalizations, human character animations, and procedure animations.

11. The method of claim 1, further comprising
applying a rate of change modifier to a physiological variable adapted to increase or decrease the rate of change of a current condition, wherein the rate of change modifier is applied individually to one or more physiological variables, or for all physiological variables equally, thereby increasing or decreasing a difficulty of the simulation.

12. The method of claim 1, further comprising
outputting an indication of a level of performance based on the current condition at an end of the simulation and an amount of time utilized to reach the current condition.

13. The method of claim 1, wherein receiving input from one or more users interacting with the computing device provides for user control via one or more of a graphical user interface, a speech recognition device, a touch screen display, and an instrumented physical device.

14. A computer implemented system for medical skills training, comprising:
a computing device with at least one processor,
a memory coupled to the processor,
an output device having visual and audio output,
an input device, and
a program residing in the memory that when executed by the processor is adapted to implement the method of claim 1.

15. A non-transitory computer-readable medium having code stored thereon for medical skills training, that when executed by a processor of a computing device implements the method of claim 1.

16. A computer implemented system for medical skills training, comprising:
a computing device with at least one processor, a memory coupled to the processor, an output device having visual and audio output, an input device, and a program residing in the memory that when executed by the processor is adapted to:
a) simulate a current condition of at least one simulated patient wherein the current condition comprises dynamic physiology, appearance, and behavior of the simulated patient using one or more physiology models;
b) output the simulated patient in the current condition on the output device comprising a visual display;
c) receive input from one or more users interacting with the computing device, wherein the input represents one or more medical interactions to be virtually applied to the simulated patient;
d) process the received inputs by the computing device using the physiology model in conjunction with one or more physiological variables that change over time based on the physiology model, in response to corresponding deterioration clocks and the received inputs; and
e) outputting one or more changes to the current condition of the simulated patient by applying different animations to the simulated patient based on the processed inputs.

17. A non-transitory computer-readable medium having code stored thereon for medical skills training, that when executed by a processor of a computing device implements a method comprising:
a) simulating by a computing device a current condition of at least one simulated patient wherein the current condition comprises dynamic physiology, appearance, and behavior of the simulated patient using one or more physiology models;
b) outputting the simulated patient in the current condition on an output device comprising a visual display;
c) receiving input from one or more users interacting with the computing device, wherein the input represents one or more medical interactions to be virtually applied to the simulated patient;
d) processing the received inputs by the computing device using the physiology model in conjunction with one or more physiological variables that change over time based on the physiology model, in response to corresponding deterioration clocks and the received inputs; and
e) outputting one or more changes to the current condition of the simulated patient by applying different animations to the simulated patient based on the processed inputs.
